(19) United States
(12) Patent Application Publication
(10) Pub. No.: US 2019/0203699 A1
(43) Pub. Date: Jul. 4, 2019

(54) METHOD AND DEVICE FOR MONITORING A STATUS OF AT LEAST ONE WIND TURBINE AND COMPUTER PROGRAM PRODUCT

(71) Applicant: fos4X GmbH, München (DE)

(72) Inventors: Mathias Müller, Gröbenzell (DE); Thomas Schauß, Gilching (DE)

(21) Appl. No.: 16/333,053

(22) PCT Filed: Sep. 13, 2017
(86) PCT No.: PCT/EP2017/073026

§ 371 Date: Mar. 13, 2019

(30) Foreign Application Priority Data
Sep. 13, 2016 (DE) 102016117190.5

(51) Int. Cl. F03D 17/00

(52) U.S. Cl. CPC F03D 17/00; F05B 2260/80

(57) ABSTRACT

The invention relates to a method (200) for monitoring a status of at least one wind turbine. The method (200) comprises: detecting first measurement signals via one or more sensors (210), wherein the first measurement signals provide one or more parameters relating to at least one rotor blade of the at least one wind turbine in a normal status; training a trainable algorithm based on the first measurement signals of the normal status (220); detecting second measurement signals via the one or more sensors (230); and recognising an undetermined anomaly via the trainable algorithm trained in the normal status, if a current status of the wind turbine, determined based on the second measurement signals, deviates from the normal status (240).

The disclosure relates to a method and a device for monitoring a status of at least one wind turbine, and relates to a computer program product. The present disclosure relates in particular to the determining of a status of a rotor blade of a wind turbine using a neural network.

### STATE OF THE ART

In conventional methods for status monitoring of rotor blades, the detected measurement data is compared with known damage patterns, and thus the amount and kind of the damage are obtained. For this purpose, detailed data bases including damage patterns and their correlation with the detected measurement parameters are provided. Especially for rotor blades of wind turbines, due to their permanently further developing and changing structure, the required data about damage patterns is incomplete or not available at all.

Consequently, there is a need to further improve a method and a device for monitoring a status of at least one wind turbine. Especially, there is a need to improve recognition of damage on rotor blades of wind turbines.

### DISCLOSURE OF THE INVENTION

It is the task of the present disclosure to indicate a method and a device for monitoring a status of at least one wind turbine, and a computer program product, which allow damage on rotor blades of wind turbines to be recognized.

This task is solved by the subject matter of the independent claims.

According to embodiments of the present disclosure, a method for monitoring a status of at least one wind turbine is indicated. The method comprises detecting first measurement signals via one or more sensors, wherein the first measurement signals provide one or more parameters relating to at least one rotor blade of the at least one wind turbine in a normal status, training a trainable algorithm based on the first measurement signals of the normal status, detecting second measurement signals via the one or more sensors, and recognizing an undetermined anomaly via the trainable algorithm trained in the normal status, if a current status of the wind turbine, determined based on the second measurement signals, deviates from the normal status.

According to a further aspect of the present disclosure a method for monitoring a status of at least one wind turbine is indicated. The device comprises one or more sensors for detecting first measurement signals, wherein the first measurement signals provide one or more parameters relating to at least one rotor blade of the at least one wind turbine in a normal status, and an electronic device including a trainable algorithm. The electronic device is configured to train the trainable algorithm based on the first measurement signals of the normal status, to receive second measurement signals detected via the one or more sensors, and to recognize an undetermined anomaly, if a current status of the wind turbine, determined based on the second measurement signals, deviates from the normal status.

According to another aspect of the present disclosure, a computer program product including a trainable algorithm is indicated. The trainable algorithm is arranged to be trained based on the first measurement signals of a normal status of a wind turbine and to recognize an undetermined anomaly, if a current status of the wind turbine, determined based on the second measurement signals, deviates from the normal status.

Preferred optional embodiments and particular aspects of the disclosure will result from the dependent claims, the drawings and the present description.

According to the embodiments of the present disclosure the trainable algorithm, which may be provided by a neural network, for example, is trained in the undamaged status of the wind turbine. A change is detected upon the first occurrence as a novelty or as an undetermined anomaly. A measurement parameter may be detected, for example, by means of sensors in a rotor blade or in other parts of the wind turbine, which measurement parameter correlates with the status of the rotor blades. By means of acceleration sensors, for example, the natural frequency of the rotor blade may be monitored. Upon a change of the status of the rotor blade, due to a damage, for example, a change of the natural frequency of the rotor blade may be observed. Due to the use of the trainable algorithm and novelty recognition, it is not necessary for damage patterns to be known. An improved and simplified recognition of damage to rotor blades of wind turbines is thus enabled.

### BRIEF DESCRIPTION OF THE DRAWINGS

Exemplary embodiments of the disclosure are illustrated in the Figures and will be described in detail below. Shown are in:

FIG. 1 a schematic representation of a device for monitoring a status of at least one wind turbine according to embodiments of the present disclosure,

FIG. 2 a schematic representation of a method for monitoring a status of at least one wind turbine according to embodiments of the present disclosure,

FIG. 3 a time axis for training the trainable algorithm and a damage recognition after the training according to embodiments of the present disclosure,

FIG. 4 a schematic representation of a method for monitoring a status of at least one wind turbine according to embodiments of the present disclosure, and

FIG. 5 a schematic representation of a wind farm having a plurality of wind turbines according to embodiments of the present disclosure.

### EMBODIMENTS OF THE DISCLOSURE

Hereinafter, identical reference numerals will be used for identical elements or elements of identical action, unless stated otherwise.

FIG. 1 shows a schematic representation of a device 100 for monitoring a status of at least one wind turbine according to embodiments of the present disclosure. The device 100 may be a measurement system or part of a measurement system.

The device 100 comprises one or more sensors 110 for detecting measurement signals, and an electronic device 120 including a trainable algorithm. The electronic device 120 may be a monitoring unit for the at least one wind turbine. The trainable algorithm may be provided by a neural network.

The trainable algorithm is trained in an undamaged status of the wind turbine, and in particular of the at least one rotor blade, using measurement signals provided by the sensors 110. In other words, the trainable algorithm learns a normal status of the wind turbine, and in particular of the at least one rotor blade, in a training phase. If in an operating phase of the wind turbine following the training phase, a change of the measurement signals or a change of the status derived therefrom is determined, this change will be detected in particular upon the first occurrence as a novelty or an undetermined anomaly. In particular, a current status of the wind turbine in the operating phase is compared with the learned normal status, wherein in case of a deviation of the current status from the normal status, the undetermined anomaly is concluded to be present when the deviation is outside a tolerance range, for example. Thus, damage patterns are not required to be provided to recognize, for example, a damage of a rotor blade. The damage recognition may in particular be performed without available data on damage patterns.

In FIG. 1, the one or more sensors 110 comprise a first sensor 112, a second sensor 114 and a third sensor 116. The present disclosure, however, is not restricted thereto, and any appropriate number of sensors may be provided. The sensors 110 may be disposed on or in a rotor blade to be monitored of a wind turbine and/or in other parts of the wind turbine.

In particular, according to the embodiments, the sensors 110 may be integrated in the rotor blade or disposed on an upper surface of the rotor blade. As an alternative or in addition, at least some of the sensors 110 may be disposed in other parts of the wind turbine, such as a hub, where the rotor blade is supported to be rotatable, and/or the tower of a wind turbine. According to embodiments which can be combined with other embodiments described herein, the sensors 110 are selected from the group consisting of acceleration sensors, fiber-optic sensors, torsion sensors, temperature sensors and flow sensors.

According to embodiments, the device 100 may comprise an output unit 130. The output unit 130 may be arranged, for example, to display that the undetermined anomaly is present. The output unit 130 may output a message or an alarm, for example, in order to inform a user about the presence of the undetermined anomaly. For this purpose, the output unit 130 may comprise a display device such as a screen, for example. According to embodiments, the message or alarm may be output optically and/or acoustically.

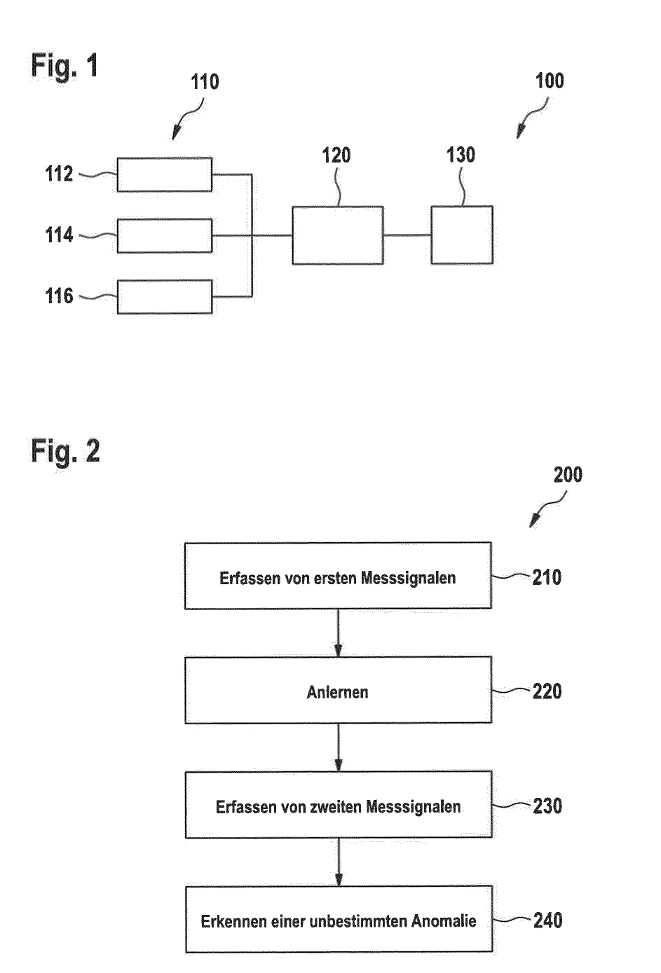

FIG. 2 shows a schematic representation of a method 200 for monitoring a status of at least one wind turbine, and in particular a status of a rotor blade of the wind turbine, according to embodiments of the present disclosure. The method 200 may employ the device described with reference to FIG. 1. The device may in particular be arranged to execute the method according to the embodiments described herein.

The method comprises in step 210, detecting first measurement signals via one or more sensors, wherein the first measurement signals indicate one or more parameters relating to at least one rotor blade of the at least one wind turbine in a normal status, in step 220, training a trainable algorithm, for example a neural network, based on the first measurement signals of the normal status, in step 230, detecting second measurement signals via the one or more sensors, and in step 240, recognizing an undetermined anomaly via the trainable algorithm trained in the normal status, if a current status of the wind turbine, determined based on the second measurement signals, deviates from the normal status. For example, at least one measurement signal of the second measurement signals may indicate a deviation from the normal status.

Typically, the normal status is depicted using the first measurement signals, and the current status is depicted using the second measurement signals. The undetermined anomaly may be recognized by comparing the normal status with the current status.

The measurement system or the trainable algorithm is trained in the undamaged status of the wind turbine. In other word, the trainable algorithm learns the normal status of the wind turbine, and in particular of the rotor blades. Every change which may be detected by comparing the current status of the wind turbine with the learned normal status, is detected as a novelty or as an undetermined anomaly upon the first occurrence. If a further damage occurs and changes the system input, it will as well be detected as a further novelty.

The normal status of the wind turbine may in this case be defined by the one or the more parameters relating to at least one rotor blade. Similarly, the current status of the wind turbine may be defined by the one or the more parameters relating to the at least one rotor blade. The parameter may be, for example a natural frequency such as a natural torsional frequency of the rotor blade. When the determined natural frequency corresponds to a normal reference value or is within a predetermined range around the normal reference value, the rotor blade is in the normal status. If the determined natural frequency in the current status deviates from the normal reference value or is outside the predetermined range, then the presence of an undetermined anomaly is recognized.

The normal status and/or the current status may relate to a single rotor blade or to all of the rotor blades of a wind turbine. According to embodiments, the normal status for a single rotor blade may moreover be learned and then be transferred to other rotor blades of, for example, identical design and/or the same type. A wind turbine may thus obtain from other wind turbines external data relating to the normal status, for example, and may thus learn from other wind turbines.

By using trainable algorithms, such as neural networks, and novelty recognition, damage patterns are not required to be known. The trainable algorithm, and in particular the untrained and/or trained trainable algorithm, in particular does neither know nor comprise any predetermined anomalies. The term “undetermined” should in this case be interpreted such that the trainable algorithm does not have any data or comparison models available in advance regarding the anomaly. According to embodiments, for example, there is no (direct) determination of the kind of the undetermined anomaly or novelty (e.g. ice deposits, cracks, heavy gust of wind, etc.) when the undetermined anomaly or novelty is recognized.

The embodiments of the present disclosure may recognize anomalies such as damages of the rotor blades without data on damage patterns being available in advance. This is in particular advantageous since, as compared to other defects in wind energy turbines, the rotor blades are relatively rarely damaged. Moreover, data on damage patterns is incomplete or not present due to the permanently further developing and changing structure of the rotor blades.

According to embodiments of the present disclosure, which may be combined with other embodiments described herein, the method 200 further comprises completing and/or updating the trainable algorithm with the recognized undetermined anomaly. In particular upon a repeated occurrence of substantially the same undetermined anomaly, the trainable algorithm is capable of identifying (recognizing again) the undetermined anomaly. The method 200 may comprise, for example, outputting a message or an alarm which indicates the repeated occurrence of the undetermined anomaly. In some embodiments, information about the history of an undetermined anomaly may be provided, such as information about a time of occurrence, a frequency of occurrence, etc.

From the number of messages or alarms within a defined period of time, for example, the origin of the alarm and/or the nature of the undetermined anomaly (ice deposits, heavy gust of wind, etc.) may be concluded. Many messages or alarms over a prolonged period may be due to a constant mass increase of the rotor blade caused by icing. A plurality of messages or alarms within a very short time could instead be indicative of a one-off damage to the rotor blade.

In some embodiments, the training of the trainable algorithm is performed in an undamaged status and/or unloaded status (e.g. without ice deposits) of the wind turbine, and in particular in an undamaged and/or unloaded status of the rotor blades. According to embodiments, the training may be performed temporally and/or locally separated prior to constructing a wind turbine. Therewith, data bases on damage patterns are not required to be provided, since the trainable algorithm learns an individual normal status of the wind turbine, and in particular of the rotor blades of the wind turbine, wherein, during the operation of the wind turbine, deviations from the previously learned normal status may be recognized by evaluating the measurement signals.

The first measurement signals and the second measurement signals indicate one or more parameters relating to the rotor blade to be monitored. According to embodiments, the one or the more parameters relating to the rotor blade are selected from the group comprising a natural frequency of the rotor blade, a temperature, an angle of attack of the rotor blade, a pitch angle, an angle of incidence and a speed of incidence. Thus, a changed natural frequency, an increased temperature at the attachment of the rotor blade to the hub and/or an unnatural angle of attack, pitch angle or angle of incidence may be recognized as an undetermined anomaly. Furthermore, an increased speed of incidence at determined areas of the rotor blade may be indicative of a damage or deformation of the rotor blade, for example.

For example, the first measurement signals and the second measurement signals may correlate with the status of the rotor blade to be monitored and/or may indicate a measurement parameter correlating with the status. In some embodiments, the natural frequency of the rotor blade may be monitored by means of acceleration sensors, with the natural frequency indicating the parameter relating to the rotor blade. In some embodiments, the method 200 may comprise performing a frequency analysis for determining the natural frequency, in particular a natural torsional frequency. Upon a change of the status of the rotor blade, e.g. by a damage or application of ice, a change of the natural frequency may be observed. The change of the natural frequency may then be recognized or determined as the undetermined anomaly, for example.

In addition to detecting the first measurement signals and/or the second measurement signals (primary measurement data detection), one or more further parameters may be used as an input to the trainable algorithm. The one or more further parameters may be operational parameters and/or environmental parameters. The operational parameters, for example, may comprise the angle of attack, the pitch angle, the rotor speed, the supplied energy, the angle of incidence and the speed of incidence. The environmental parameters, for example, may comprise a wind velocity and an ambient temperature or outdoor temperature.

Typically, the angle of attack is defined with respect to a reference plane. The pitch angle may indicate an angle setting of the rotor blade with respect to a hub, where the rotor blade is supported to be rotatable. The angle of incidence may indicate an angle between the plane defined by the rotor blade and a wind direction. The speed of incidence may indicate a relative speed or relative mean speed at which the air impinges upon the rotor blade. The wind velocity may indicate an absolute wind velocity.

According to some embodiments which can be combined with other embodiments described herein, the first measurement signals and the second measurement signals are optical signals. The sensors may be optical sensors such as fiber-optic sensors or fiber-optic torsion sensors, for example.

According to another aspect of the present disclosure, a computer program product including a trainable algorithm is indicated. The trainable algorithm is arranged to be trained based on first measurement signals of a normal status of a wind turbine, and to recognize an undetermined anomaly, if a current status of the wind turbine, determined based on the second measurement signals, deviates from the learned normal status. The computer program product may be, for example, a storage medium including the trainable algorithm stored thereon.

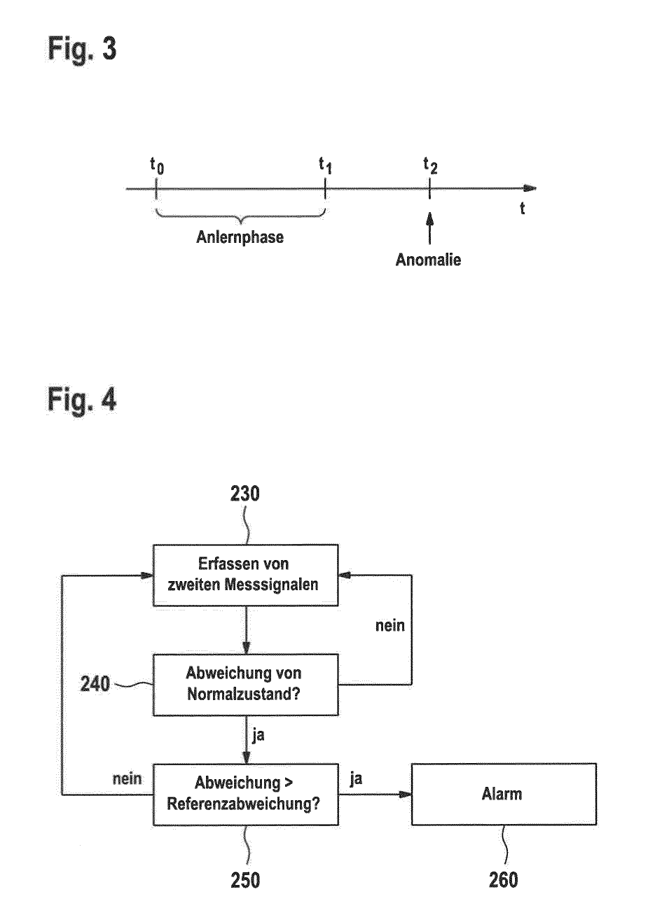

FIG. 3 shows a time axis for the training of the trainable algorithm and a damage recognition after the training according to embodiments of the present disclosure.

The training of the trainable algorithm is performed in a training phase in an undamaged status and/or unloaded status (e.g. without ice deposits) of the wind turbine, and in particular in an undamaged status and/or unloaded status of the rotor blades. The training phase may be performed for a predetermined duration between a time t0 and a time t1. The predetermined duration may be in the range of several hours, several days, and several weeks. According to embodiments, the predetermined duration may be more than one week, such as 1 to 5 weeks, 1 to 3 weeks or 1 to 2 weeks, for example. In further embodiments, the predetermined duration may be less than one week. The predetermined duration, that is to say the training period, may be selected based on a desired quality of the novelty recognition.

According to embodiments, the training may be performed temporally and/or locally separated prior to constructing the wind turbine. In other words, the training phase may take place before the operational phase, that is, before the wind turbine goes into operation for generating power, for example. After the end of the training phase, the wind turbine is operated and the trainable algorithm monitors the current status of the wind turbine, and in particular of the rotor blades, by means of the second measurement signals. If the second measurement signals or the current status determined therefrom, indicate, at a time t2, for example, a deviation from the previously learned normal status, the undetermined anomaly may be recognized.

FIG. 4 shows a schematic representation of a method for monitoring a status of at least one wind turbine according to embodiments of the present disclosure.

According to embodiments which can be combined with other embodiments described herein, the method comprises in step 230 detecting second measurement signals via the sensors, and in step 240 determining whether the current status determined, based on the second measurement signals, deviates from the normal status. The undetermined anomaly may be recognized, for example, when a natural frequency of the current status determined by the second measurement signals deviates from the natural frequency determined by the first signals, which indicates the normal status, and/or is outside a tolerance range.

In a step 250 of the method, the undetermined anomaly may be determined or recognized when the deviation of the current status from the normal status is greater than a reference deviation, e.g. when the deviation is outside the tolerance range. According to embodiments, an undetermined anomaly is not recognized when the deviation of the current status is less than the reference deviation. The trainable algorithm, for example, is programmed or trained such that it recognizes only determined (e.g. extreme) novelties. A heavy gust of wind, for example, is not recognized as an undetermined anomaly but as the normal status.

The reference deviation may be defined by a predetermined range around a normal reference value of the normal status. The predetermined range may be a tolerance range. If, for example, the natural frequency determined from the second measurement signals corresponds to the normal reference value or is within the predetermined range around the normal reference value, then the rotor blade is in the normal status and an undetermined anomaly is not recognized. If, however, the natural frequency of the current status determined from the second measurement signals is outside the predetermined range, then the presence of an undetermined anomaly is recognized.

The predetermined range may be defined, for example, by a predetermined percentage deviation from the normal reference value. The reference deviation may correspond to a deviation of 5%, 10%, 15% or 20% from the normal reference value, for example.

In some embodiments of the present disclosure, the method may comprise in step 260, if an undetermined anomaly is recognized, a message or an alarm relating to the recognized undetermined anomaly to be output. The message or the alarm may be output optically and/or acoustically. The message or the alarm may be performed by e-mail and/or a warning signal.

According to embodiments which can be combined with other embodiments described herein, the method further comprises a plausibility check of the recognized undetermined anomaly to be carried out. If, for example, a deviation from the normal status is greater than a maximum reference deviation, then a measurement error may be concluded, for example. In a further example, ice deposits may be excluded by measuring the outdoor temperature.

A determination of the origin of the alarm may be performed in further steps. This may be performed, for example, automatically and by software technology or manually by an engineer. If the number of alarm messages within a defined period of time is counted, the origin of the alarm may be concluded therefrom. Many alarms over a prolonged period may be due to a constant mass increase of the rotor blade caused by icing. A plurality of alarms within a very short time could be indicative of a one-off damage to the rotor blade.

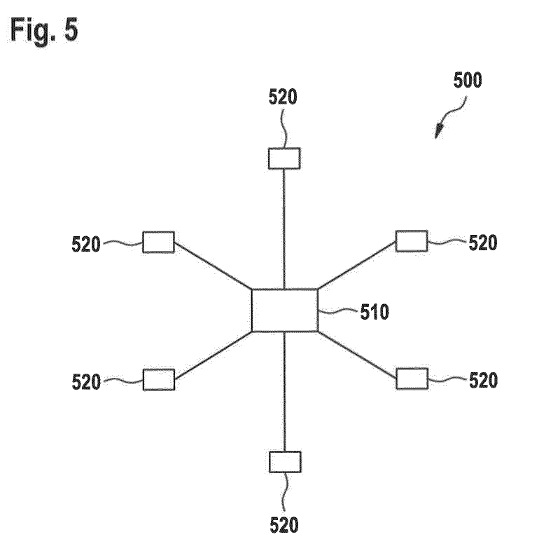

FIG. 5 shows a schematic representation of a wind farm 500 including a plurality of wind turbines 520 according to embodiments of the present disclosure.

According to embodiments, the at least one wind turbine may be a plurality of wind turbines 520. The embodiments of the present disclosure may in particular be used for monitoring a status of a wind farm including a plurality of wind turbines 520. A single trainable algorithm may thus be used for monitoring the status of the plurality of wind turbines 520. Each of the plurality of wind turbines 520 may comprise sensors providing at least the second measurement signals. This allows a great number of wind turbines to be monitored by a single monitoring unit 510 comprising the trainable algorithm.

According to embodiments of the present disclosure, the trainable algorithm, which may be provided by a neural network, for example, is trained in the undamaged status of the wind turbine. A change in the current status is detected upon the first occurrence as a novelty or an undetermined anomaly. For example, a measurement parameter may be detected in a rotor blade or in other parts of the wind turbine, which measurement parameter correlates with the status of the rotor blades. The natural frequency of the rotor blade may be monitored by acceleration sensors, for example. Upon a change of the status of the rotor blade, for example due to a damage, a change of the natural frequency of the rotor bade may be observed. Through the use of the trainable algorithm and the novelty recognition, damage patterns are not required to be known. An improved and simplified damage recognition on rotor blades of wind turbines may thus be enabled.

1. A method for monitoring a status of at least one wind turbine, comprising:
detecting first measurement signals via one or more sensors, wherein the first measurement signals provide one or more parameters relating to at least one rotor blade of the at least one wind turbine in a normal status;
training a trainable algorithm based on the first measurement signals of the normal status;
detecting second measurement signals via the one or more sensors; and
recognizing an undetermined anomaly via the trainable algorithm trained in the normal status, if a current status of the wind turbine, determined based on the second measurement signals, deviates from the normal status.

2. The method according to claim 1, wherein the normal status is depicted using the first measurement signals, and the current status is depicted using the second measurement signals, and wherein the undetermined anomaly is recognized by comparing the normal status with the current status.

3. The method according to claim 1, wherein the trained trainable algorithm does not comprise any predetermined anomalies.

4. The method according claim 1, further comprising completing the trainable algorithm with the recognized undetermined anomaly.

5. The method according to claim 4, wherein, upon a repeated occurrence of substantially the same undetermined anomaly, the trainable algorithm recognizes the undetermined anomaly again.

6. The method according to claim 1, wherein the training of the trainable algorithm is performed in an undamaged status of the wind turbine.

7. The method according to claim 1, wherein the first measurement signals and the second measurement signals are optical signals.

8. The method according to claim 1, wherein the undetermined anomaly is recognized when the deviation of the current status from the normal status is greater than a reference deviation.

9. The method according to claim 8, wherein an undetermined anomaly is not recognized when the deviation of the current status from the normal status is less than the reference deviation.

10. The method according to claim 1, wherein the trainable algorithm is provided by a neural network.

11. The method according to claim 1, further comprising:
outputting a message relating to the recognized undetermined anomaly.

12. The method according to claim 1, further comprising:
carrying out a plausibility check of the recognized undetermined anomaly.

13. The method according to claim 1, wherein the one or more parameters is or are selected from the group comprising the natural frequency of the rotor blade, a rotor speed, a supplied energy, a temperature, an angle of attack of the rotor blade, a pitch angle and a speed of incidence.

14. The method according to claim 1, wherein the at least one wind turbine is a plurality of wind turbines.

15. A device for monitoring a status of at least one wind turbine, comprising:
one or more sensors for detecting first measurement signals, wherein the first measurement signals indicate one or more parameters relating to at least one rotor blade of the wind turbine in a normal status; and
an electronic device including a trainable algorithm and configured to
train the trainable algorithm based on the first measurement signals of the normal status,
receive second measurement signals detected via the one or more sensors; and
recognize an undetermined anomaly, if a current status of the wind turbine, determined based on the second measurement signals, deviates from the normal status.

16. A computer program product, comprising a trainable algorithm which is arranged to be trained based on first measurement signals of a normal status of a wind turbine, and to recognize an undetermined anomaly, if a current status, determined based on the second measurement signals, deviates from the normal status.
